(19) United States
(12) Patent Application Publication
(10) Pub. No.: US 2026/0213451 A1
(43) Pub. Date: Jul. 23, 2026

(54) TERMINAL STORAGE MEMBER

(71) Applicant: Yazaki Corporation, Tokyo (JP)

(72) Inventors: Kazuhide IKEYA, Makinohara-shi (JP); Mai YOKOYAMA, Makinohara-shi (JP)

(73) Assignee: Yazaki Corporation, Tokyo (JP)

(21) Appl. No.: 19/439,693

(22) Filed: Jan. 5, 2026

(30) Foreign Application Priority Data
Jan. 22, 2025 (JP) 2025-008901

(51) Int. Cl. H01R 13/422

(52) U.S. Cl. CPC H01R 13/4223

(57) ABSTRACT

A terminal storage member includes: a storage chamber including a first partition wall portion, a second partition wall portion facing the first partition wall portion, the first and second partition wall portions partitioning both sides of a terminal to which an electric wire is connected, a bottom wall portion connected to one end of the first partition wall portion and one end of the second partition wall portion facing the one end of the first partition wall portion, and a storage opening, the storage chamber being capable of storing the terminal through the storage opening; and a terminal locking portion that is provided only on the first partition wall portion out of the first and the second partition wall portions in the storage opening, protrudes from the first partition wall portion toward the second partition wall portion, and fixes the terminal within the storage chamber.

### BACKGROUND OF THE INVENTION

### Field of the Invention

An embodiment of the present invention relates to a terminal storage member.

Priority is claimed on Japanese Patent Application No. 2025-008901 filed in Japan on January 22, 2025, the content of which is incorporated herein by reference.

### Description of Related Art

Some connectors that electrically connect circuit boards and the like of various electronic devices to electric wires include a terminal storage member that stores terminals to which the electric wires are connected, and a housing into which this terminal storage member is inserted. Such a terminal storage member is formed with a member for locking the terminal.

For example, Patent Document 1 discloses a connector including a terminal storage block that stores female terminals to which electric wires are connected, and a cover block into which the terminal storage block is inserted and assembled. Patent Document 1 also discloses that the female terminal stored in a storage chamber is clamped at its tip by a regulating portion that regulates a storage position of the female terminal and a locking portion that regulates the movement of the female terminal toward the rear of the storage chamber. Furthermore, Patent Document 1 discloses that the female terminals can be prevented from slipping out of the storage chamber by forming a sealing piece at the upper end of the partition wall of the terminal storage block that protrudes toward the adjacent partition wall.

### Prior Art Document

### Patent Document

Patent Document 1: Japanese Unexamined Patent Application, First Publication No. 2011-14353

### SUMMARY OF THE INVENTION

With the technology of Patent Document 1, the sealing piece at the opening of the storage chamber may make it difficult to easily insert the female terminal into the storage chamber. Therefore, it can be difficult to automate the wiring of electric wires and the like.

One embodiment of the present invention provides a terminal storage member that facilitates automation of wiring.

A terminal storage member according to an embodiment of the present invention includes: a storage chamber including a first partition wall portion, a second partition wall portion facing the first partition wall portion, the first partition wall portion and the second partition wall portion partitioning both sides of a terminal to which an electric wire is connected, a bottom wall portion connected to one end of the first partition wall portion and one end of the second partition wall portion facing the one end of the first partition wall portion, and a storage opening, the storage chamber being capable of storing the terminal through the storage opening; and a terminal locking portion that is provided only on the first partition wall portion out of the first partition wall portion and the second partition wall portion in the storage opening, protrudes from the first partition wall portion toward the second partition wall portion, and fixes the terminal within the storage chamber.

With the terminal storage member according to one embodiment of the present invention, the automation of wiring is easy.

### BRIEF DESCRIPTION OF THE DRAWINGS

FIG. 1 is an exploded perspective view illustrating a terminal storage unit according to an embodiment of the present invention;

FIG. 2 is a plan view illustrating a terminal storage member according to the embodiment of the present invention;

FIG. 3 is a cross-sectional view taken along line I-I in FIG. 2;

FIG. 4 is a perspective view illustrating a cross section of the terminal storage unit according to the embodiment of the present invention;

FIG. 5 is a front view illustrating the terminal storage unit according to the embodiment of the present invention;

FIG. 6 is a cross-sectional view taken along line II-II in FIG. 5;

FIG. 7 is a perspective view illustrating a state in which a terminal according to the embodiment of the present invention is stored in the terminal storage member;

FIG. 8 is a perspective view illustrating a state in which the terminal according to the embodiment of the present invention is stored in the terminal storage member;

FIG. 9 is a perspective view illustrating a state in which the terminal according to the embodiment of the present invention is stored in the terminal storage member;

FIG. 10 is a cross-sectional view taken along line II-II in FIG. 5, illustrating a state in which the terminal according to the embodiment of the present invention is stored in the terminal storage member;

FIG. 11 is a cross-sectional view taken along line II-II in FIG. 5, illustrating a state in which the terminal according to the embodiment of the present invention is stored in the terminal storage member;

FIG. 12 is a cross-sectional view taken along line II-II in FIG. 5, illustrating a state in which the terminal according to the embodiment of the present invention is stored in the terminal storage member;

FIG. 13 is a cross-sectional view taken along line II-II in FIG. 5, illustrating a state in which the terminal according to the embodiment of the present invention is stored in the terminal storage member;

FIG. 14 is a cross-sectional view taken along line III-III in FIG. 6, illustrating a state in which the terminal according to the embodiment of the present invention is stored in the terminal storage member;

FIG. 15 is a cross-sectional view taken along line III-III in FIG. 6, illustrating a state in which the terminal according to the embodiment of the present invention is stored in the terminal storage member; and

FIG. 16 is a cross-sectional view taken along line III-III in FIG. 6, illustrating a state in which the terminal according to the embodiment of the present invention is stored in the terminal storage member.

### DETAILED DESCRIPTION OF THE INVENTION

An embodiment will hereinafter be described with reference to the drawings. In the following description, constitutions having the same or similar functions are denoted by the same reference numbers. Note that the following embodiments are examples of representative embodiments of the present invention, and the scope of the present invention is not limited by these descriptions, and various combinations, modifications, and changes are possible within the scope of the gist thereof.

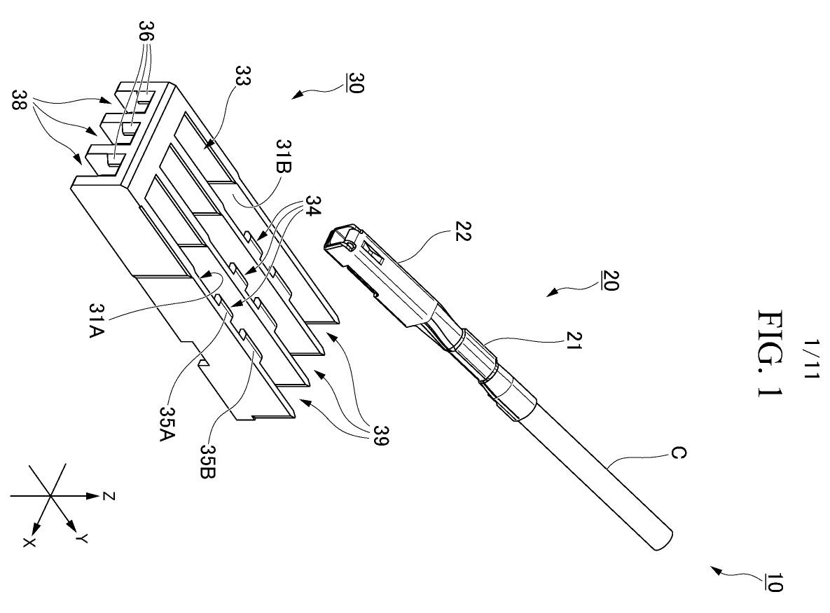

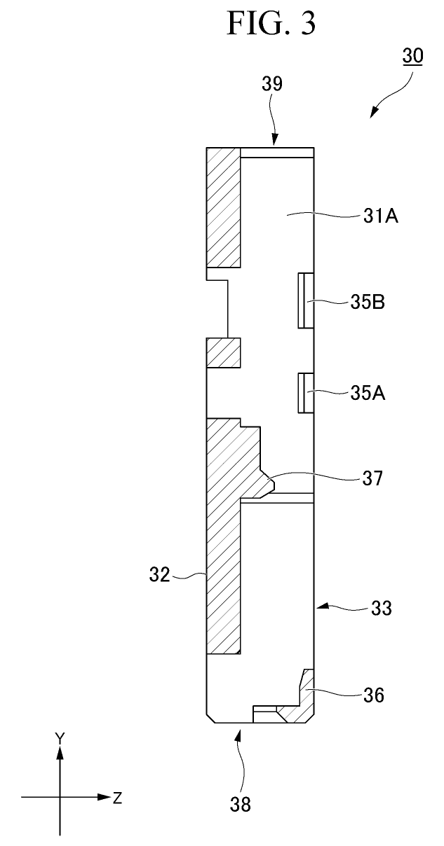

In the present application, an X direction, a Y direction, and a Z direction are defined as follows. The X direction is a width direction of a terminal storage member 30, which will be described later, and is a direction from a second partition wall portion 31B toward a first partition wall portion 31A (see FIG. 1). The Y direction is a direction that intersects (for example, is orthogonal to) the X direction. The Y direction is an extending direction of the terminal storage member 30, which will be described later, and is a direction from a terminal hole 38 toward an electric wire opening 39 (see FIG. 1). The Z direction is a direction that intersects (for example, is orthogonal to) the X direction and the Y direction. The Z direction is a thickness (height) direction of the terminal storage member 30, which will be described later, and is a direction from a bottom wall portion 32 toward a storage opening 33 (see FIG. 3).

### Embodiment

FIG. 1 is an exploded perspective view illustrating a terminal storage unit 10 according to an embodiment of the present invention. The terminal storage unit 10 includes a female type terminal (hereinafter abbreviated as “female terminal”) 20 to which one end of an electric wire (wire harness) C is connected, and a terminal storage member 30 to which the female terminal (terminal) 20 is attached.

The female terminal (terminal) 20 includes a main body portion 21, a tip portion 22 connected to the front portion of the main body portion 21, and an electrical contact portion 23. An elastic electrical contact portion 23 (see FIG. 6) protrudes downward from the tip portion 22, and the electric wire C is connected to the rear portion of the main body portion 21. This female terminal 20 is attached to a storage chamber 34 by inserting the female terminal into each terminal storage space of the storage chamber 34 of the terminal storage member 30 in a state before the terminal storage member 30 is inserted into a male housing (not illustrated).

Furthermore, the main body portion 21 has a recessed portion (hereinafter referred to as a recess 24, see FIG. 6) on the upper surface side of the middle portion. When the female terminal 20 is inserted into the terminal storage member 30, the recess 24 engages with a terminal fixing portion 37 (see FIG. 6) provided in the storage chamber 34 inside the terminal storage member 30. This engagement restrains the female terminal 20 from moving in the forward and backward directions.

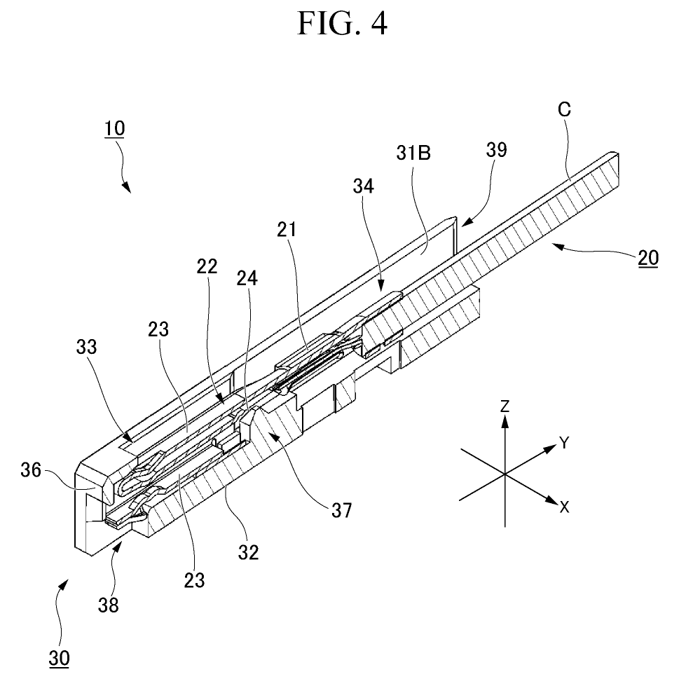

As illustrated in FIGS. 1 to 6, the terminal storage member 30 includes a storage chamber 34, a first terminal locking portion (terminal locking portion) 35A, and a second terminal locking portion (terminal locking portion) 35B. The storage chamber 34 includes a first partition wall portion 31A, a second partition wall portion 31B facing the first partition wall portion 31A, a bottom wall portion 32, and a storage opening 33. The terminal storage member 30 extends parallel to a longitudinal direction of the female terminal 20.

The first partition wall portion 31A and the second partition wall portion 31B are partition wall portions for partitioning both sides of the female terminal 20. Each of the first partition wall portion 31A and the second partition wall portion 31B may partition adjacent female terminals 20, for example. Each of the first partition wall portion 31A and the second partition wall portion 31B extends parallel to the longitudinal direction of the female terminal 20 (Y direction in FIG. 1). The bottom wall portion 32 is connected to one end of the first partition wall portion 31A and one end of the second partition wall portion 31B facing the one end of the first partition wall portion 31A. The storage opening 33 is defined by the other end of the first partition wall portion 31A, the other end of the second partition wall portion 31B, the first terminal locking portion 35A, and the second terminal locking portion 35B. The storage chamber 34 can store the female terminal 20 through the storage opening 33.

The terminal storage member 30 is formed with three storage chambers 34 in the width direction (X direction in FIG. 1) for storing a plurality of (for example, three) female terminals 20 to which electric wires C are connected, respectively. Each storage chamber 34 has a storage opening 33 formed above the storage chamber 34 in the height direction (Z direction in FIG. 1), and one female terminal 20 can be stored through the storage opening 33.

After the female terminals 20 are stored in the respective storage chambers 34, the terminal storage member 30 is inserted into the insertion chambers (not illustrated) of the male housing. The terminal storage member 30 is a kit-cut type terminal storage plate in which a plurality of storage chambers 34, each storing a corresponding one of a plurality of female terminals 20, are aligned and connected, and the plurality of storage chambers 34 can be cut into the desired number of units for use.

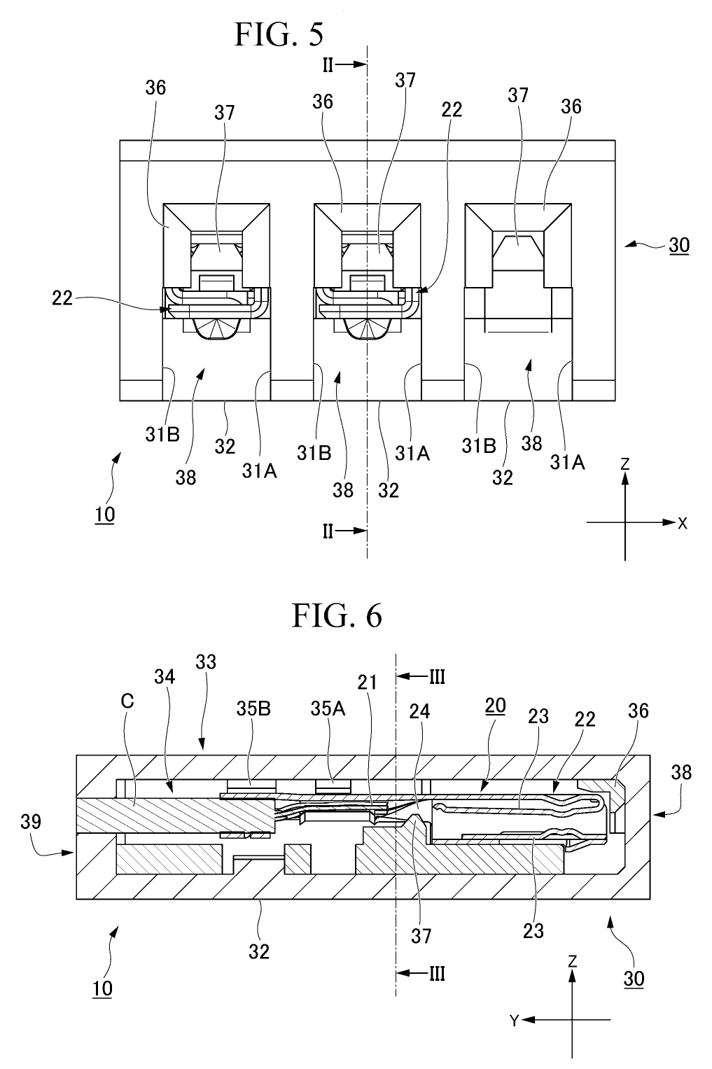

As illustrated in FIGS. 1 and 5, the storage chamber 34 has a plurality of spaces each partitioned by the first partition wall portion 31A and the second partition wall portion 31B. The storage opening 33 of the storage chamber 34 is provided with a first terminal locking portion 35A and a second terminal locking portion 35B that protrude from the first partition wall portion 31A of the storage chamber 34 toward the opposing second partition wall portion 31B and fix the terminals within the storage chamber 34.

The first terminal locking portion 35A and the second terminal locking portion 35B are each provided only on the first partition wall portion 31A out of the first partition wall portion 31A and the second partition wall portion 31B. For example, each of the first terminal locking portion 35A and the second terminal locking portion 35B may protrude only from the first partition wall portion 31A toward the second partition wall portion 31B out of the first partition wall portion 31A and the second partition wall portion 31B. The second partition wall portion 31B may have a flat surface along the XY plane across the portion facing the first terminal locking portion 35A and the second terminal locking portion 35B, for example. The storage opening 33 may be narrowed, for example, at the portions where the first terminal locking portion 35A and the second terminal locking portion 35B protrude. In the portion where the first terminal locking portion 35A and the second terminal locking portion 35B protrude, of a pair of contours of the storage opening 33 each extending in the Y direction, for example, the contour on the first partition wall portion 31A side may be recessed in the X direction, and the contour on the second partition wall portion 31B side may not be recessed and may extend in a straight line. That is, in the portion where the first terminal locking portion 35A and the second terminal locking portion 35B protrude, of the pair of contours of the storage opening 33 each extending in the Y direction, only the contour on the first partition wall portion 31A side may be recessed in the X direction.

The first terminal locking portion 35A and the second terminal locking portion 35B come into contact with the upper portion of the female terminal 20 stored in the storage chamber 34, thereby preventing the female terminal 20 from slipping outward from each storage chamber 34. The first terminal locking portion 35A and the second terminal locking portion 35B are made of a flexible material such as plastic.

Each of the first terminal locking portion 35A and the second terminal locking portion 35B has an inclined surface that is located outside the storage chamber 34 and is inclined toward the second partition wall portion 31B from the first partition wall portion 31A to approach the bottom wall portion 32. For example, in FIG. 1, each of the first terminal locking portion 35A and the second terminal locking portion 35B has an inclined surface that slopes downward toward the storage chamber 34 as such an inclined surface. This inclined surface makes it easy to store the female terminal 20 in the storage chamber 34 from directly above.

The lower surfaces (surfaces on the storage chamber 34 side) of the first terminal locking portion 35A and the second terminal locking portion 35B are formed in a horizontal plane parallel to the bottom wall portion 32. This horizontal plane increases the contact area of the first terminal locking portion 35A and the second terminal locking portion 35B with the upper portion of the female terminal 20, making it easier to fix the female terminal 20 in the storage chamber 34.

The first terminal locking portion 35A and the second terminal locking portion 35B are formed in a part of the storage opening 33 formed at the upper end of the first partition wall portion 31A, for example, in the center of the storage opening 33 in the direction in which the first partition wall portion 31A extends. By forming the first terminal locking portion 35A and the second terminal locking portion 35B in the center of the storage opening 33, it becomes easier to store the female terminal 20 in the storage chamber 34 from above the storage opening 33. In addition, a plurality of first terminal locking portions 35A and a plurality of second terminal locking portions 35B can be formed on the upper end of the first partition wall portion 31A, and this configuration can strengthen the prevention of the female terminal 20 from slipping out of the storage chamber 34.

At the front end of the storage chamber 34 (in the direction in which the tip portion 22 of the female terminal 20 is inserted), there is provided a terminal regulating portion 36 that abuts the tip portion 22 of the female terminal 20 and regulates the storage position of the tip portion 22 of the female terminal 20, as illustrated in FIGS. 1 to 6. The terminal regulating portion 36 is configured as an L-shape that locks the tip portion of the upper side (storage opening 33 side) of the electrical contact portion 23, which has spring properties and protrudes at the tip portion 22, when the female terminal 20 is stored in the storage chamber 34. With this configuration, the female terminal 20 stored in the storage chamber 34 can be prevented and restrained from moving in the extending direction (Y direction) and the height direction (Z direction) of the storage chamber 34.

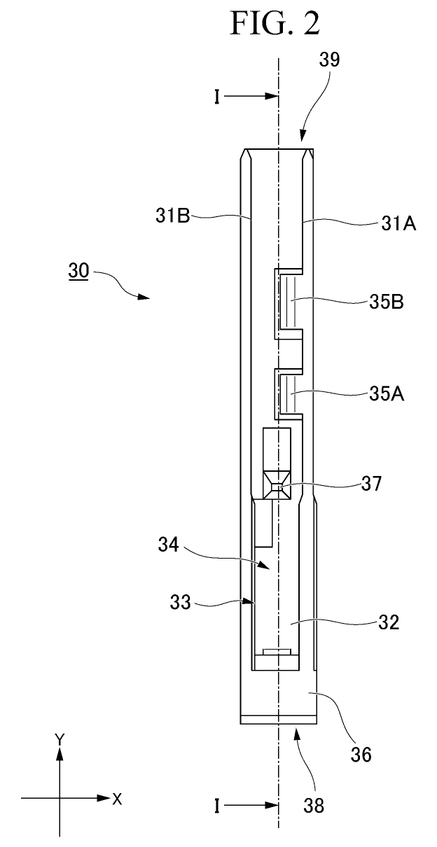

As illustrated in FIGS. 2 to 6, the bottom wall portion 32 of the storage chamber 34 is provided with a terminal fixing portion 37 that protrudes from the bottom wall portion 32 in the direction of the storage opening 33 (Z direction) and engages with the recess 24 of the female terminal 20 to fix the main body portion 21 of the female terminal 20. The terminal fixing portion 37 is located at the center of the width direction (X direction) of the storage chamber 34 and is configured as a protrusion that is inclined toward the protruding tip. With this configuration, the female terminal 20 stored in the storage chamber 34 can be prevented and restrained from moving in the width direction (X direction) and the extending direction (Y direction) of the storage chamber 34.

As illustrated in FIG. 1, a terminal hole 38 is provided at the front end of the storage chamber 34. With this configuration, the tip portion of a male terminal (not illustrated) provided on a male type connector (not illustrated) can be fitted into the terminal hole 38 and mated with the electrical contact portion 23 provided on the tip portion 22 of the female terminal 20. At the rear end of the storage chamber 34 (in the direction in which the electric wire C of the female terminal 20 extends), an electric wire opening 39 for allowing the electric wire C of the female terminal 20 to extend outside the terminal storage member 30 is provided.

### Procedure for Storing Female Terminal 20

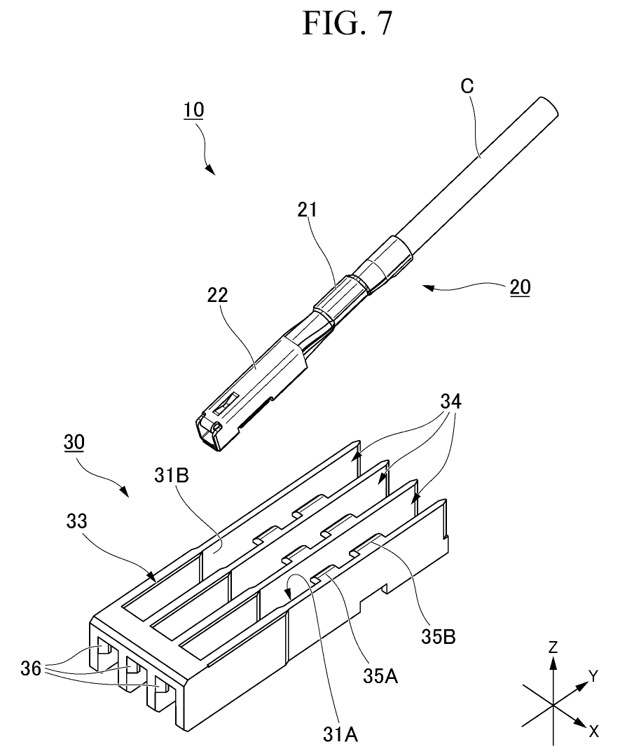

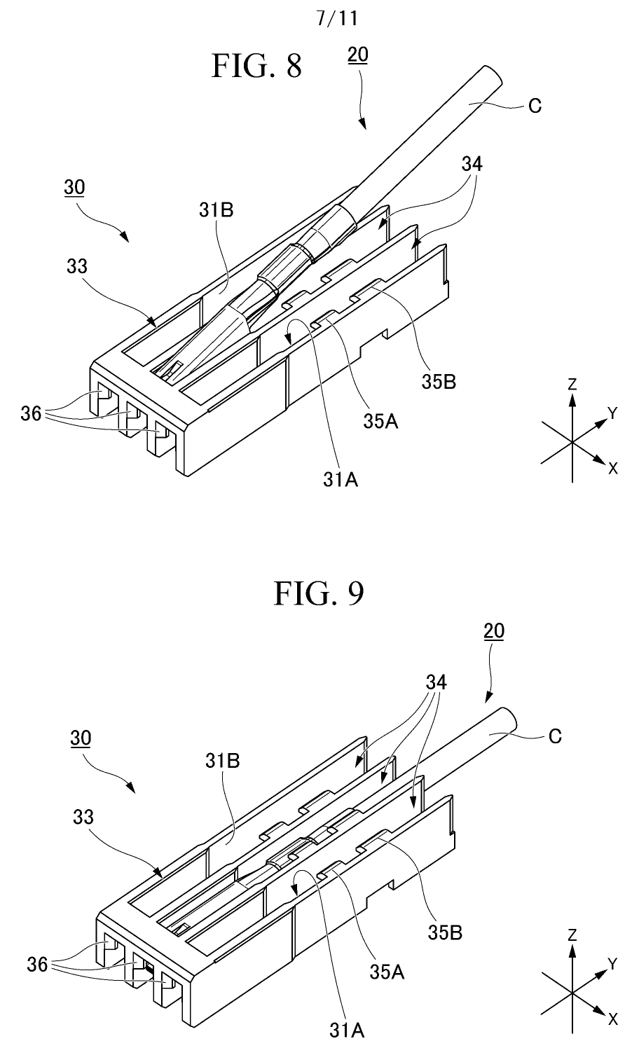

Next, the procedure for mounting and storing the female terminal 20 in the terminal storage member 30 of the present embodiment will be described with reference to FIGS. 7 to 15. FIG. 7 illustrates the female terminal 20 in a state before it is stored in the terminal storage member 30. FIG. 8 illustrates an intermediate state in which the tip portion 22 of the female terminal 20 is being stored in the terminal storage member 30. FIG. 9 illustrates a state after the female terminal 20 has been stored in the terminal storage member 30. The female terminal 20 is stored in the terminal storage member 30 in the order of FIGS. 7, 8, and 9 as follows.

First, as illustrated in FIG. 7, the tip portion 22 of the female terminal 20 is oriented toward the terminal hole 38 of the terminal storage member 30 (in the −Y direction). Then, the female terminal 20 is brought from directly above (+Z direction) the storage chamber 34 of the terminal storage member 30, in a direction parallel to the extending direction (Y direction) of the storage chamber 34 and moved close to the storage opening 33 of the storage chamber 34 to start the storage operation.

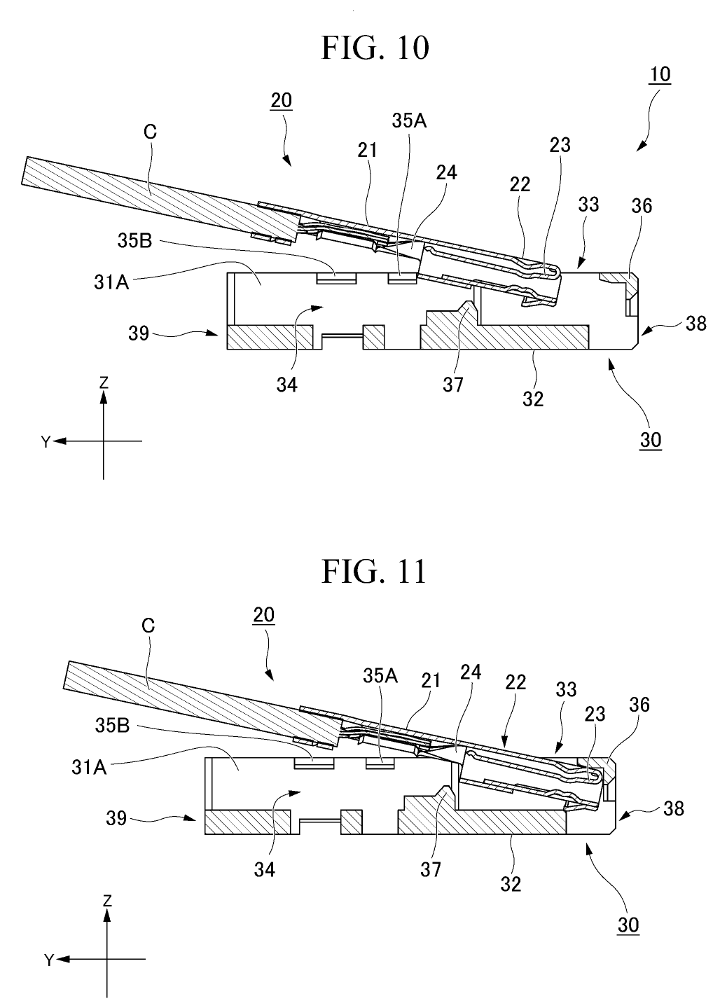

First, as illustrated in FIGS. 8 and 10, the tip portion 22 of the female terminal 20 is brought close to the storage opening 33 and inserted into the storage chamber 34 at an angle oblique to the extending direction of the storage chamber 34 from the storage opening 33 of the storage chamber 34 toward the terminal regulating portion 36 and the terminal hole 38.

Second, as illustrated in FIG. 11, the tip portion 22 of the female terminal 20 inserted into the storage chamber 34 is pushed in until it abuts the terminal regulating portion 36, and then moved to a position between the terminal regulating portion 36 and the terminal fixing portion 37.

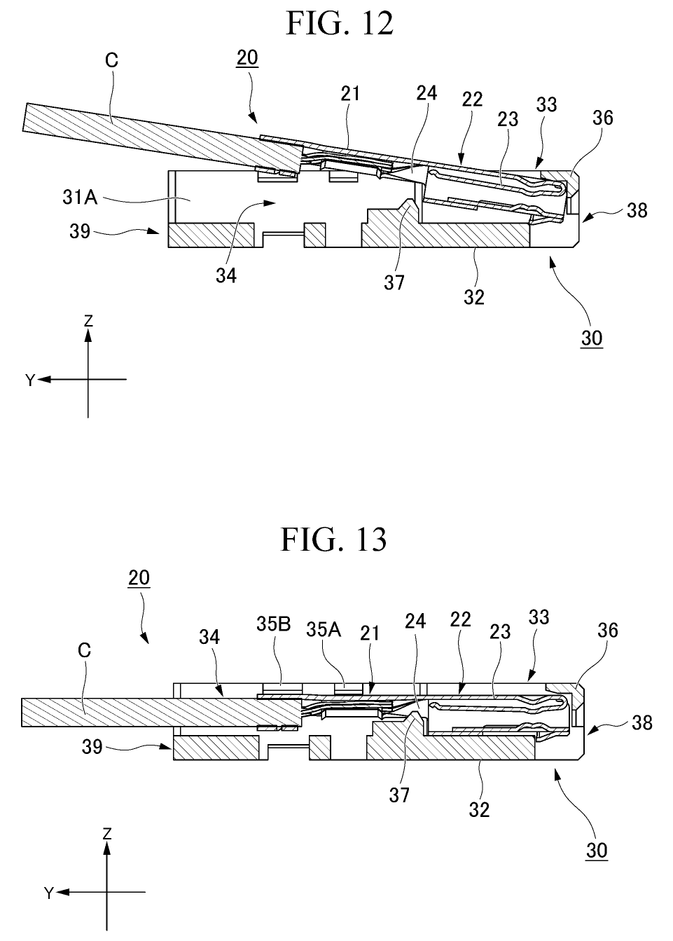

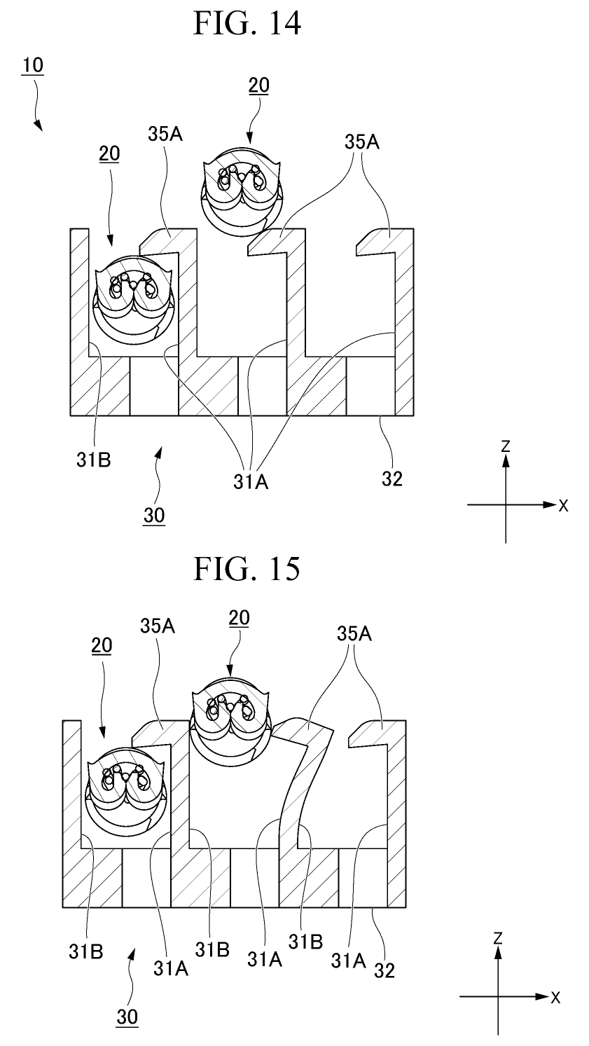

Third, as illustrated in FIGS. 12 and 14, after the tip portion 22 is inserted obliquely relative to the extending direction of the storage chamber 34, the lower surface of the main body portion 21 of the female terminal 20 is pressed against the upper surfaces (the outer surfaces relative to the storage chamber 34) of the first terminal locking portion 35A and the second terminal locking portion 35B. Furthermore, when the main body portion 21 is pushed toward the storage chamber 34, the first partition wall portion 31A, which is provided with the first terminal locking portion 35A and the second terminal locking portion 35B, bends in the width direction (+X direction) of the storage chamber 34, widening the storage opening 33 and allowing the main body portion 21 to be inserted into the storage chamber 34 (see FIG. 15).

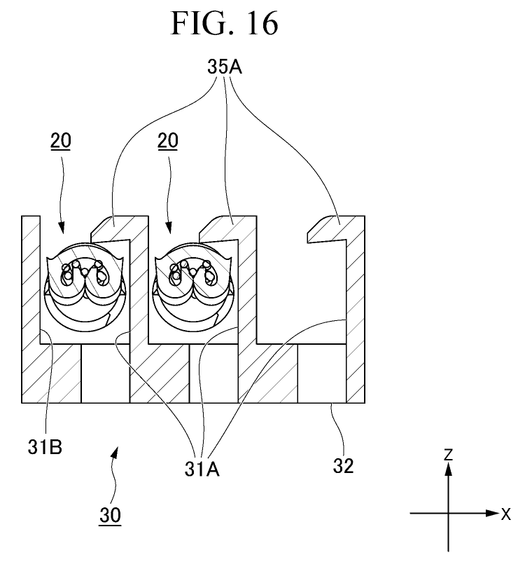

Fourth, as illustrated in FIGS. 9, 13 and 16, when the main body portion 21 of the female terminal 20 is pushed in until it contacts the bottom wall portion 32 of the storage chamber 34 and stored, the first terminal locking portion 35A and the second terminal locking portion 35B return to their original positions. As the first terminal locking portion 35A and the second terminal locking portion 35B return, the female terminal 20 is locked from an upper side by the first terminal locking portion 35A and the second terminal locking portion 35B. Furthermore, the recess 24 of the female terminal 20 and the terminal fixing portion 37 in the storage chamber 34 are engaged with each other, preventing the female terminal 20 from moving in the extending direction of the storage chamber 34. At this time, the elastic electrical contact portion 23 of the tip portion 22 sandwiched between the terminal regulating portion 36 and the terminal fixing portion 37 exerts an elastic force in a direction that pushes the terminal regulating portion 36 and the terminal fixing portion 37 apart. As a result, this elastic force acts as a locking force for holding the female terminal 20 in the storage chamber 34.

After the female terminals 20 are stored in each of the storage chambers 34 of the terminal storage member 30, the terminal storage member 30 with the female terminals 20 stored therein is inserted into the insertion chamber (not illustrated) of the male housing and fixed by engaging with the insertion chamber.

### Effects of Present Embodiment

As a comparative example of the terminal storage member 30, as shown in Patent Document 1, there is a terminal storage member in which a sealing piece (terminal locking portion) is formed at the upper end (storage opening) of the partition wall of the terminal storage block, protruding toward the adjacent partition wall, thereby preventing the female terminal from slipping out of the storage chamber. In such a comparative example, the sealing piece is difficult to bend, and it may be difficult to store the terminal in the storage chamber.

Furthermore, as in this comparative example, simply forming a sealing piece on the upper end of the partition wall of the terminal storage block does not sufficiently fix the female terminal, and there is a likelihood that the female terminal may slip out of the storage chamber.

Another comparative example is a two-stage storage process in which the female terminal is partially inserted into the storage chamber from above the storage chamber and then slid in the longitudinal direction of the storage chamber to set the female terminal in the correct position. In the case of this comparative example, it is not easy to store the terminals in the storage chamber, making it difficult to automate the wiring of the electric wires.

In contrast to these comparative examples, the terminal locking portions 35A and 35B of the present embodiment are provided only on the first partition wall portion 31A out of the first partition wall portion 31A and the second partition wall portion 31B in the storage opening 33 and protrude from the first partition wall portion 31A toward the second partition wall portion 31B.

With this configuration, it is possible to ensure a space for the terminal locking portions 35A and 35B to bend when the female terminal 20 is inserted. For example, by having the terminal locking portions 35A and 35B located only in the first partition wall portion 31A on one side of the first partition wall portion 31A and the second partition wall portion 31B, it is possible to ensure a space for the terminal locking portions 35A and 35B to bend when the female terminal 20 is inserted. Therefore, it is easy to automate the wiring.

Furthermore, with this configuration, the terminal storage member 30 can suppress rattling of the female terminals 20 in the up and down direction and improve vibration resistance, thereby ensuring contact reliability. In addition, the female terminal 20 in the storage chamber 34 of the inserted terminal storage member 30 can be regulated from slipping out of the storage opening 33.

The terminal storage member 30 also includes a plurality of terminal locking portions (first terminal locking portion 35A and second terminal locking portion 35B) in the direction in which the first partition wall portion 31A extends. This configuration increases the fixing force of the female terminal 20 stored in the storage chamber 34 compared to when only one terminal locking portion is provided, thereby further strengthening the prevention of the female terminal 20 from slipping out of the storage chamber 34. The protruding length (X direction), width (Y direction), and thickness (Z direction) of the plurality of terminal locking portions 35A and 35B may be uniform or may differ from one another.

In addition, in the terminal storage member 30, a plurality of terminal locking portions (first terminal locking portion 35A and second terminal locking portion 35B) may be formed in the center of the storage opening 33 in the direction in which the first partition wall portion 31A extends. This configuration makes it easier to store the female terminal 20 in the storage chamber 34 than when a plurality of terminal locking portions are formed at the end of the storage opening 33 in the direction in which the first partition wall portion 31A extends.

In addition, the terminal storage member 30 further includes a terminal regulating portion 36 that abuts the tip portion 22 of the female terminal 20 and regulates the storage position of the tip portion 22 of the female terminal 20, and a terminal fixing portion 37 that protrudes from the bottom wall portion 32 toward the storage opening 33 and fixes the main body portion 21 of the female terminal 20. With this configuration, after the female terminal 20 is stored in the storage chamber 34, the terminal regulating portion 36 regulates the movement of the female terminal 20 in the extending direction and the height direction of the storage chamber 34, and the terminal fixing portion 37 regulates the movement of the female terminal 20 in the width direction and the extending direction of the storage chamber 34. Therefore, it is possible to more securely prevent the female terminal 20 from slipping out of the storage chamber 34.

In the terminal storage member 30, the storage chamber 34 is made of a flexible material and includes a plurality of storage chambers 34 for storing a plurality of female terminals 20, respectively. With this configuration, various types of wire harnesses can be used together in one terminal storage unit 10 including the terminal storage member 30. Furthermore, in the terminal storage member 30, the storage chamber 34 is made of a flexible material, and the terminal locking portions 35A and 35B are located on the first partition wall portion 31A on one side of the storage chamber 34. With this configuration, even if there are a plurality of adjacent storage chambers 34, a space is ensured for the terminal locking portions 35A and 35B to easily bend when the female terminals 20 are inserted, and therefore the female terminals 20 can be stored in each storage chamber 34 at the same time. Therefore, the work can be completed more quickly.

Furthermore, the terminal storage member 30 can be formed into a kit-cut type terminal storage plate in which a plurality of storage chambers 34, each storing a corresponding one of a plurality of female terminals 20, are aligned and connected, and the plurality of storage chambers 34 can be cut into the desired number of units for use. This configuration allows the terminal storage member 30 to be utilized in accordance with the number of female terminals 20 required and the purpose.

Each of the terminal locking portions 35A and 35B has an inclined surface that is located outside the storage chamber 34 and is inclined toward the second partition wall portion 31B from the first partition wall portion 31A to approach the bottom wall portion 32. According to this configuration, since the female terminal 20 can be easily pushed into the storage chamber 34 from above the storage opening 33, the female terminal 20 can be stored in the terminal storage member 30 in a single process.

In the above embodiment, the connector including the terminal storage unit 10 can include a male housing as the housing. However, the connector may include any housing. As a modification example, the connector may include a female connector as the housing instead of the male housing.

In the above embodiment, the female terminal 20 as a terminal is attached to the terminal storage member 30. However, any type of terminal may be attached to the terminal storage member 30. As a modification example, instead of the female terminal 20, a male terminal as a terminal may be attached to the terminal storage member 30.

In the above embodiment, the terminal storage member 30 includes the first partition wall portion 31A as the first partition wall portion and the second partition wall portion 31B as the second partition wall portion. However, either one may be the first partition wall portion and either one may be the second partition wall portion. As a modification example, the terminal storage member 30 may include a first partition wall portion 31A as the second partition wall portion and a second partition wall portion 31B as the first partition wall portion.

Several embodiments and modification examples have been described above. However, the embodiment and the modification examples are not limited to the examples described above. For example, the embodiment and the modification examples may be implemented in combination with each other.

### REFERENCE SIGNS LIST

10 Terminal storage unit

20 Female terminal (terminal)

21 Main body portion

22 Tip portion

23 Electrical contact portion

24 Recess

30 Terminal storage member

31A First partition wall portion

31B Second partition wall portion

32 Bottom wall portion

33 Storage opening

34 Storage chamber

35A First terminal locking portion (terminal locking portion)

35B Second terminal locking portion (terminal locking portion)

36 Terminal regulating portion

37 Terminal fixing portion

38 Terminal hole

39 Electric wire opening

C Electric wire

What is claimed is:

1. A terminal storage member comprising:
a storage chamber including a first partition wall portion, a second partition wall portion facing the first partition wall portion, the first partition wall portion and the second partition wall portion partitioning both sides of a terminal to which an electric wire is connected, a bottom wall portion connected to one end of the first partition wall portion and one end of the second partition wall portion facing the one end of the first partition wall portion, and a storage opening, the storage chamber being capable of storing the terminal through the storage opening; and
a terminal locking portion that is provided only on the first partition wall portion out of the first partition wall portion and the second partition wall portion in the storage opening, protrudes from the first partition wall portion toward the second partition wall portion, and fixes the terminal within the storage chamber.

2. The terminal storage member according to claim 1, wherein
the terminal locking portion includes a plurality of terminal locking portions in a direction in which the first partition wall portion extends.

3. The terminal storage member according to claim 1, further comprising:
a terminal regulating portion that abuts a tip portion of the terminal and regulates a storage position of the tip portion of the terminal; and
a terminal fixing portion that protrudes from the bottom wall portion toward the storage opening and fixes a main body portion of the terminal.

4. The terminal storage member according to claim 1, wherein
the terminal includes a plurality of terminals, and
the storage chamber includes a plurality of storage chambers for storing the plurality of terminals, the plurality of storage chambers being made of a flexible material.

5. The terminal storage member according to claim 4, wherein
the terminal storage member is a kit-cut type terminal storage plate in which the plurality of storage chambers for storing the plurality of terminals are aligned and connected, and the plurality of storage chambers are capable of being cut into a desired number of units for use.
